(19) United States
(12) Patent Application Publication
(10) Pub. No.: US 2026/0273448 A1
(43) Pub. Date: Sep. 17, 2026

(54) EXTRACTION OF A NICOTINIC COMPONENT FROM A SUBSTRATE USING A BASE

(71) Applicant: R. J. Reynolds Tobacco Company, Winston-Salem, NC (US)

(72) Inventors: Robert Owen Bussey, III, Raleigh, NC (US); Joshua Isaacs, Winston-Salem, NC (US); Ryan Mills, Greensboro, NC (US)

(21) Appl. No.: 19/567,860

(22) Filed: Mar. 16, 2026

Related U.S. Application Data
(60) Provisional application No. 63/772,948, filed on Mar. 17, 2025.

(51) Int. Cl. B01D 53/04; B01D 1/00; B01D 11/02

(52) U.S. Cl. CPC B01D 53/04; B01D 1/00; B01D 11/0288; B01D 2257/70

(57) ABSTRACT

The disclosure provides a method of extracting nicotinic components from substrates. The method includes contacting the substrate with a strong base in a solvent to form a mixture; heating the mixture at an elevated temperature to form a vapor containing the nicotinic component; and releasing the vapor containing the nicotinic component, forming a decontaminated substrate.

### CROSS-REFERENCE TO RELATED APPLICATIONS

This application claims the benefit of U.S. Provisional Application No. 63/772,948, filed Mar. 17, 2025, which is herein incorporated by reference in its entirety and for all purposes.

### TECHNICAL FIELD

The present disclosure relates to methods for decontaminating a substrate containing a nicotinic component. Such substrates include, but are not limited to, e-liquids, tobacco materials, and waste polymeric packaging materials formerly utilized in the storage of tobacco and/or nicotine-containing products.

### BACKGROUND

There are many categories of products intended for oral use and enjoyment. For example, oral tobacco products containing nicotine, which is known to have both stimulant and anxiolytic properties, have been available for many years. Conventional formats for so-called “smokeless” tobacco products include moist snuff, snus, and chewing tobacco, which are typically formed almost entirely of particulate, granular, or shredded tobacco, and which are either portioned by the user or presented to the user in individual portions, such as in single-use pouches. More recent product formats contain purified nicotine, such as pouched products containing a powdered or granular composition, lozenges, pastilles, liquids, gels, emulsions, meltable compositions, and the like. See for example, the types of products set forth in U.S. Pat. No. 6,668,839 to Williams; U.S. Pat. No. 7,810,507 to Dube et al.; and U.S. Pat. No. 8,627,828 to Strickland et al.; as well as US Patent App. Pub. Nos. 2010/0291245 to Gao et al; 2011/0139164 to Mua et al.; 2012/0037175 to Cantrell et al.; 2015/0230515 to Lampe et al., 2021/0330590 to Hutchens et al.; 2022/0160675 to Gerardi et al.; and 2022/0071984 to Poole et al., each of which is incorporated herein by reference.

It may be desirable to remove nicotinic components, including but not limited to nicotine, from a variety of different materials to facilitate disposal or recycling of said materials. For example, tobacco or nicotine-containing products are generally stored in polymeric packaging, such as plastic pouches and/or plastic cans. It is generally desirable to recycle, reuse, or alternatively, safely dispose of such plastic materials once the product has been consumed. Particularly, it is desirable to recycle such polymeric materials to conserve resources and avoid the environmental impact of landfill disposal. However, over time, a portion of the nicotine in the product may migrate from the product and be adsorbed or absorbed onto or into the polymeric material of the packaging. The presence of this residual nicotine may reduce the options available for disposal or recycling of such materials. For example, in certain countries, the residual nicotine content must be less than 0.25% by weight in order for the plastic material to be deemed suitable for recycling.

### BRIEF SUMMARY

The present disclosure generally provides a method for extracting a nicotinic component from a substrate, such as a polymeric material, an ion exchange resin, an e-liquid composition, or a tobacco material. Accordingly, in one aspect is provided a method for extracting a nicotinic component from a substrate comprising the nicotinic component. The method generally comprises contacting the substrate with a solution of a strong base in a solvent; heating at an elevated temperature to form a vapor containing the nicotinic component; and releasing the vapor containing the nicotinic component. The method may further comprise capturing the nicotinic component from the vapor.

The disclosure includes, without limitations, the following embodiments.

Embodiment 1: A method for extracting a nicotinic component from a substrate comprising the nicotinic component at a first concentration, the method comprising:
i) receiving the substrate; and
ii) removing at least a portion of the nicotinic component from the substrate, wherein removing comprises:
a) contacting the substrate with a solution of a strong base in a solvent in a vessel to form a mixture;
b) heating the mixture at an elevated temperature to form a vapor containing the nicotinic component; and
c) releasing the vapor containing the nicotinic component from the vessel, forming a decontaminated substrate having a second concentration of the nicotinic component, wherein the second concentration of the nicotinic component is lower than the first concentration of the nicotinic component.

Embodiment 2: The method of embodiment 1, wherein a pH of the solution of the strong base is about 9.5 or higher.

Embodiment 3: The method of embodiment 1 or 2, wherein a concentration of the strong base in the solvent is from about 0.1 to about 10 molar (M).

Embodiment 4: The method of any one of embodiments 1-3, wherein the strong base is an alkali metal hydroxide.

Embodiment 5: The method of any one of embodiments 1-3, wherein the strong base is ammonium hydroxide.

Embodiment 6: The method of any one of embodiments 1-5, wherein the solvent comprises water, a polar organic solvent, or a combination thereof.

Embodiment 7: The method of any one of embodiments 1-5, wherein the solvent comprises methanol or ethanol.

Embodiment 8: The method of any one of embodiments 1-7, wherein contacting the substrate with the solution of the strong base in the solvent is performed at a temperature from about 20° C. to about 200° C., such as from about 20° C. to about 50° C.

Embodiment 9: The method of any one of embodiments 1-8, wherein the contacting is performed for a first period of time prior to said heating in step b), the first period of time being from about 5 minutes to about 2 days, such as from about 30 minutes to about 24 hours.

Embodiment 10: The method of any one of embodiments 1-9, wherein in step b), the elevated temperature is in a range from about 50° C. to about 200° C.

Embodiment 11: The method of any one of embodiments 1-10, wherein step a) and step b) are conducted simultaneously, at a temperature from about 50° C. to about 200° C.

Embodiment 12: The method of any one of embodiments 1-11, wherein the contacting and/or the heating is performed under a pressure equal to or less than atmospheric pressure.

Embodiment 13: The method of any one of embodiments 1-12, wherein step ii) further comprises adding an additional amount of solvent, adding an additional amount of the solution of a strong base in a solvent, or both, during or after any one or more of steps a) through c).

Embodiment 14: The method of any one of embodiments 1-11, wherein the contacting and/or the heating is performed at a pressure greater than atmospheric pressure.

Embodiment 15: The method of any one of embodiments 1-14, wherein the vessel is in fluid communication with an external containment system configured to capture the vapor containing the nicotinic compound.

Embodiment 16: The method of any one of embodiments 1-15, wherein the external containment system is further configured to capture any solvent vaporized from the vessel.

Embodiment 17: The method of any one of embodiments 1-16, wherein releasing the vapor containing the nicotinic compound from the vessel comprises venting the vessel to an external containment system.

Embodiment 18: The method of any one of embodiments 1-17, wherein at least a portion of the solvent remains in the chamber following step c).

Embodiment 19: The method of any one of embodiments 1-18, further comprising separating the decontaminated substrate from the solvent.

Embodiment 20: The method of any one of embodiments 1-19, further comprising removing residual solvent from the decontaminated substrate, such as by washing the decontaminated substrate with water, drying the decontaminated substrate, or both.

Embodiment 21: The method of any one of embodiments 1-20, wherein the second concentration of the nicotinic component is about 0.25% nicotine by weight or less, such as about 0.1% nicotine by weight or less, or about 0.0001% to about 0.01% nicotine by weight, based on the total weight of the decontaminated substrate.

Embodiment 22: The method of any one of embodiments 15-21, wherein the external containment system comprises a solid adsorbent configured to capture the vapor, the method comprising passing the vapor containing the nicotinic component through a bed of solid adsorbent.

Embodiment 23: The method of embodiment 22, wherein the solid adsorbent comprises activated carbon, a zeolite, activated alumina, a solid phase microextraction fiber, or a combination thereof.

Embodiment 24: The method of any one of embodiments 15-23, wherein the external containment system comprises a vessel containing an acidified solvent, the method comprising passing the vapor containing the nicotinic component through the acidified solvent.

Embodiment 25: The method of any one of embodiments 1-24, wherein the substrate comprises an e-liquid composition.

Embodiment 26: The method of any one of embodiments 1-24, wherein the substrate comprises a polymeric material, an ion exchange resin, a tobacco material, a non-tobacco botanical material, or a combination thereof.

Embodiment 27: The method of any one of embodiments 1-24, wherein the substrate comprises a waste polymeric packaging material previously used for storage of a product comprising a nicotinic component.

Embodiment 28: The method of embodiment 27, wherein the waste polymeric packaging material comprises polypropylene, polyethylene, polyvinyl chloride, an ethylene vinyl acetate co-polymer, polyvinylidene dichloride, a polyester terephthalate, an ethylene methacrylic acid co-polymer, a cyclohexylenedimethylene terephthalate glycol copolymer, or a combination thereof.

Embodiment 29: The method of embodiment 27, wherein the waste polymeric packaging material comprises polypropylene, low-density polyethylene, or a combination thereof.

Embodiment 30: The method of any one of embodiments 1-29, further comprising dividing the substrate into smaller pieces prior to the contacting.

Embodiment 31: The method of embodiment 30, wherein the dividing comprises one or more of cutting or shredding the substrate into smaller pieces or grinding the substrate into particles.

These and other features, aspects, and advantages of the disclosure will be apparent from a reading of the following detailed description together with the accompanying drawing, which is briefly described below. The disclosure includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosure, in any of its various aspects and embodiments, should be viewed as intended to be combinable unless the context clearly dictates otherwise.

### BRIEF DESCRIPTION OF THE DRAWINGS

Having thus described aspects of the disclosure in the foregoing general terms, reference will now be made to the accompanying drawings, which are not necessarily drawn to scale. The drawings are exemplary only and should not be construed as limiting the disclosure.

FIG. 1 is a cross-sectional view of a non-limiting pouched smokeless tobacco product embodiment, taken across the width of the product, showing an outer pouch filled with a composition comprising nicotine.

FIGS. 2A, 2B, and 2C are schematic side and front views of a multi-compartment flexible sachet for holding a nicotine product according to a non-limiting embodiment of the present disclosure.

FIG. 3 is schematic side view of a roll of a panel material for sachets according to a non-limiting embodiment of the present disclosure.

FIG. 4A is a perspective view of a rigid container for holding a nicotine product according to a non-limiting embodiment of the present disclosure.

FIG. 4B is an exploded perspective view of the container of FIG. 4A according to a non-limiting embodiment of the present disclosure.

FIG. 5 a partial cross-sectional view of a cartridge for holding a nicotine product according to a non-limiting embodiment of the present disclosure.

FIG. 6 is a system for removal of a nicotinic component from a substrate according to a non-limiting embodiment of the present disclosure.

FIG. 7A is a gas chromatography-mass spectroscopy chromatogram showing peak areas of nicotine by total ion count for a sample extraction performed at 100° C. according to Example 5.

FIG. 7B is a gas chromatography-mass spectroscopy chromatogram showing peak areas of nicotine by total ion count for a sample extraction performed at 140° C. according to Example 5.

FIG. 7C is a gas chromatography-mass spectroscopy chromatogram showing peak areas of nicotine by total ion count for a sample extraction performed at 200° C. according to Example 5.

FIG. 8A is a gas chromatography-mass spectroscopy chromatogram showing peak areas of nicotine by total ion count for a pre-extraction sample of a substrate.

FIG. 8B is a gas chromatography-mass spectroscopy chromatogram showing peak areas of nicotine by total ion count for a sample of a substrate following two extractions according to a non-limiting embodiment of the present disclosure.

### DETAILED DESCRIPTION

The present disclosure will now be described more fully hereinafter with reference to example embodiments thereof. These example embodiments are described so that this disclosure will be thorough and complete, and will fully convey the scope of the disclosure to those skilled in the art. Indeed, the disclosure may be embodied in many different forms and should not be construed as limited to the embodiments set forth herein; rather, these embodiments are provided so that this disclosure will satisfy applicable legal requirements.

As used in this specification and the claims, the singular forms “a,” “an,” and “the” include plural referents unless the context clearly dictates otherwise.

The term “about” used throughout this specification is used to describe and account for small fluctuations. For example, the term “about” can refer to less than or equal to ±10%, such as less than or equal to ±5%, less than or equal to ±2%, less than or equal to ±1%, less than or equal to ±0.5%, less than or equal to ±0.2%, less than or equal to ±0.1% or less than or equal to ±0.05%. All numeric values herein are modified by the term “about,” whether or not explicitly indicated. A value modified by the term “about” of course includes the specific value. For instance, “about 5.0” must include 5.0.

Reference to “dry weight percent” or “dry weight basis” refers to weight on the basis of dry ingredients (i.e., all ingredients except water). Reference to “wet weight” refers to the weight of the composition including water. Unless otherwise indicated, reference to “weight percent” of a composition reflects the total wet weight of the composition (i.e., including water).

### Method for Extracting Nicotinic Component

The present disclosure provides a method for extracting a nicotinic component from a substrate comprising said nicotinic component. The method generally comprises receiving the substrate; and removing at least a portion of the nicotinic component from the substrate. The removing generally comprises: a) contacting the substrate with a solution of a strong base in a solvent in a vessel to form a mixture; b) heating the mixture at an elevated temperature to form a vapor containing the nicotinic component; and c) releasing the vapor containing the nicotinic component from the vessel, forming a decontaminated substrate having a second concentration of the nicotinic component, wherein the second concentration of the nicotinic component is lower than the first concentration of the nicotinic component. The various method steps and substrates are further described herein below.

### Nicotinic Component

As used herein, the term “nicotinic component” denotes a compound or mixture of compounds having pharmacological activity at one or more nicotinic receptor subtypes, including but not limited to, agonists, antagonists, and allosteric modulators of the a₄b₂, a₇, and/or a₃b₄ subtypes, and which may be present in free base form, salt form, ion paired form, or as a resin complex. Non-limiting examples of nicotinic compounds include nicotine and nicotine analogs, such as optionally substituted 3-(1-methylpyrrolidin-2-yl)pyridines, optionally substituted 3-(azetidin-2-yl)pyridine, and optionally substituted 3-(azetidin-2-ylmethoxy)pyridines.

As used herein, the term “substituted 3-(1-methylpyrrolidin-2-yl)pyridine” refers to a compound having a 3-(1-pyrrolidin-2-yl)pyridine) scaffold and bearing one or more non-hydrogen substituents on the pyrrolidine ring, and optionally on the pyridine ring.

As used herein, the term “substituted 3-(azetidin-2-yl)pyridine” refers to a compound having a 3-(azetidin-2-yl)pyridine scaffold and bearing one or more non-hydrogen substituents on the azetidine ring, and optionally on the pyridine ring.

As used herein, the term “substituted 3-(azetidin-2-ylmethoxy)pyridine” refers to a compound having a 3-(azetidin-2-ylmethoxy)pyridine scaffold and bearing one or more non-hydrogen substituents on the azetidine ring, and optionally on the pyridine ring.

In some embodiments, the nicotinic component comprises nicotine. The source of the nicotine may vary and may be natural or synthetic. Nicotine may be tobacco-derived (e.g., a tobacco extract) or non-tobacco derived (e.g., synthetic or otherwise obtained). In some embodiment, the nicotine is naturally occurring and obtained as an extract from a Nicotiana species (e.g., tobacco). The nicotine can have the enantiomeric form S-(−)-nicotine, R-(+)-nicotine, or a mixture of S-(−)-nicotine and R-(+)-nicotine. In some embodiments, the nicotine is in the form of S-(−)-nicotine (e.g., in a form that is virtually all S-(−)-nicotine) or a racemic mixture composed primarily or predominantly of S-(−)-nicotine (e.g., a mixture composed of about 95 weight parts S-(−)-nicotine and about 5 weight parts R-(+)-nicotine). In some embodiments, the nicotine is employed in virtually pure form or in an essentially pure form. In some embodiments, the nicotine a purity of greater than about 95 percent, such as greater than about 98 percent or greater than about 99 percent, on a weight basis.

In some embodiments, the nicotinic component comprises or is free base nicotine. Free base nicotine can be adsorbed in for example, a microcrystalline cellulose material to form a microcrystalline cellulose-nicotine carrier complex. See, for example, the discussion of nicotine in free base form in US Pat. Pub. No. 2004/0191322 to Hansson, which is incorporated herein by reference.

In some embodiments, the nicotinic component comprises or is a nicotine salt. Salts of nicotine can be provided using the types of ingredients and techniques set forth in U.S. Pat. No. 2,033,909 to Cox et al. and Perfetti, Beitrage Tabakforschung Int., 12:43-54 (1983), which are incorporated herein by reference. Additionally, salts of nicotine are available from sources such as Pfaltz and Bauer, Inc. and K&K Laboratories, Division of ICN Biochemicals, Inc. Typically, the nicotine salt is a hydrochloride, dihydrochloride, monotartrate, bitartrate, benzoate, sulfate, salicylate, or nicotine zinc chloride, including hydrates of any thereof. In some embodiments, the nicotine salt is nicotine bitartrate.

In some embodiments, at least a portion of the nicotinic component is present in an ion paired form. Ion pairing describes the partial association of oppositely charged ions in relatively concentrated solutions to form distinct chemical species called ion pairs. The strength of the association (i.e., the ion pairing) depends on the electrostatic force of attraction between the positive and negative ions (i.e., protonated nicotine and the conjugate base of an acid). By “conjugate base” is meant the base resulting from deprotonation of the corresponding acid (e.g., benzoate is the conjugate base of benzoic acid).

In some embodiments, at least a portion of the nicotinic component is in the form of a resin complex, where the nicotinic component is bound in an ion-exchange resin or other acidic polymeric material. In some embodiments, the residual nicotinic component is resin-complexed nicotine, such as nicotine polacrilex, which is nicotine bound to, for example, a polymethacrylic acid ion exchange resin, such as Amberlite IRP64, Purolite C115HMR, or Doshion P551. See, for example, U.S. Pat. No. 3,901,248 to Lichtneckert et al., which is incorporated herein by reference. Another example is a nicotine-polyacrylic carbomer complex, such as with Carbopol 974P.

In some embodiments, the nicotinic component comprises 2-methyl-5-(1-methylpyrrolidin-2-yl)pyridine. In some embodiments, the nicotinic component comprises or is free base 2-methyl-5-(1-methylpyrrolidin-2-yl)pyridine, a salt thereof, a resin complex thereof, 2-methyl-5-(1-methylpyrrolidin-2-yl)pyridine in ion paired form, or a combination thereof.

For the avoidance of doubt, reference throughout the present disclosure to “nicotine” or a “nicotine component” is intended to encompass other nicotinic components as described herein above, and reference to nicotine or a nicotine component should not be construed as limited solely to nicotine.

Although the focus of the disclosure is on nicotine extraction, the same extraction techniques could be applied to other active ingredients or flavorants, such as those that leach into a packaging material from the product contained therein, each as described herein below. Additional active ingredients include cannabinoids or cannabimimetics, such as tetrahydrocannabinol (THC) and cannabidiol (CBD), terpenes, botanicals, and the like.

### Substrate

The nicotinic component is generally present in a substrate. As used herein, the term “substrate” refers to any matrix including a nicotinic component, such as a polymeric material, a pouched product, a tobacco material, an e-liquid composition, or the like.

In some embodiments, the substrate is a nicotine product or a polymeric packaging material previously utilized in the storage and/or dispensing of a product comprising nicotine or a nicotine component. As used herein, the term “nicotine product” denotes any tobacco or nicotine-containing product, including tobacco materials intended for combustion (e.g., cigarette or pipe tobacco), dry snuff intended to be placed in the nasal cavity, oral nicotine products configured for oral use and intended to be placed in the oral cavity of a user, and consumables used in aerosol-producing devices such as e-cigarettes or tobacco heating devices.

Conventional formats for oral nicotine products commonly referred to as “smokeless tobacco” include, for example, moist snuff, snus, and chewing tobacco, which are typically formed almost entirely of particulate, granular, or shredded tobacco, and which are either portioned by the user or presented to the user in individual portions, such as in single-use pouches or sachets.

Example tobacco products may further include pelletized tobacco products (e.g., compressed or molded pellets produced from powdered or processed tobacco, such as those formed into the general shape of a coin, cylinder, bean, pellet, sphere, orb, strip, obloid, cube, bead, or the like), extruded or cast pieces of tobacco (e.g., as strips, films or sheets, including multilayered films formed into a desired shape), products incorporating tobacco carried by a solid substrate (e.g., where substrate materials range from edible grains to inedible cellulosic sticks), extruded or formed tobacco-containing rods or sticks, tobacco-containing capsule-like materials having an outer shell region and an inner core region, straw-like (e.g., hollow formed) tobacco-containing shapes, sachets or packets containing tobacco (e.g., snus-like products), pieces of tobacco-containing gum, and the like.

In addition, traditional tobacco materials and non-tobacco materials have been combined with other ingredients to form product formats distinct from traditional smokeless products, with example formats including pouched products, lozenges, pastilles, gels, and the like. For example, oral nicotine compositions often include such ingredients as sweeteners, binders, colorants, pH adjusters, fillers, flavoring agents, disintegration aids, antioxidants, oral care additives, and preservatives. For example, oral products which are tobacco-free, including pouched products, chews, melts, pastilles, and the like are known. Such products generally comprise a nicotine component, a filler such as a cellulosic material (microcrystalline cellulose and/or cellulose ethers), and various combinations of sugar alcohols, gums, non-tobacco botanical materials, humectants, sweeteners, binders, organic acids, and flavoring agents.

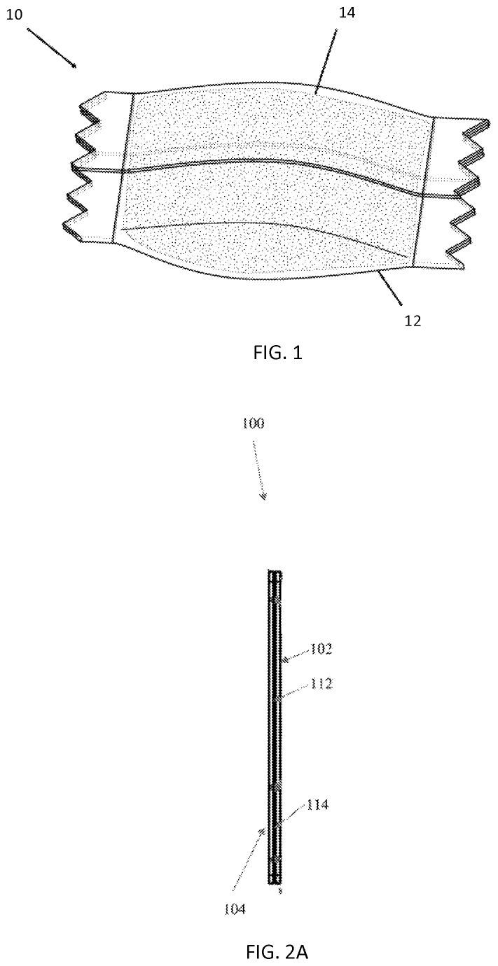

In some embodiments, the oral nicotine product is disposed within a moisture-permeable container (e.g., a water-permeable pouch) to form a pouched oral product. Accordingly, in certain embodiments, the product is disposed within a moisture-permeable packet or pouch that acts as a container for use of the product to provide a pouched product configured for oral use. Referring to FIG. 1, there is shown one embodiment of a pouched product 10. The pouched product 10 includes a moisture-permeable container in the form of a pouch 12, which contains a material 14 comprising, for example, a composition comprising purified nicotine or tobacco.

Non-limiting examples of suitable types of pouches are set forth in, for example, U.S. Pat. No. 5,167,244 to Kjerstad, which is incorporated herein by reference. Pouches can be provided as individual pouches, or a plurality of pouches (e.g., 2, 4, 5, 10, 12, 15, 20, 25 or 30 pouches) can be connected or linked together (e.g., in an end-to-end manner) such that a single pouch or individual portion can be readily removed for use from a one-piece strand or matrix of pouches.

### Packaging for Nicotine Products

Nicotine products as described above are commonly stored in resealable containers or other packaging devices (e.g., cans, packets, pouches, bags, sacks, cases, sachets, etc.). For example, smokeless tobacco products or tobacco intended for smoking may be stored in and dispensed from flexible pouches or sachets. Accordingly, in some embodiments, the substrate comprises or is a packaging material previously used for the storage or dispensing of a nicotine product.

Nicotine-containing products such as those described herein, when stored within packaging materials as described herein, may, over time, adsorb or adsorb some portion of the nicotine present in the product e.g., by evaporation, sublimation, direct contact, or any other process of migration. Accordingly, polymeric materials used for the storage and/or dispensing of nicotine-containing products may comprise residual nicotine. The amount of residual nicotine may vary based on, for example the duration of exposure of the material to the nicotine containing product, the nature of the material, and the nicotine content of the product stored therein. In some embodiments, the packaging material comprises residual nicotine in an amount greater than about 0.01% by weight, such as from about 0.01% to about 1% by weight. In some embodiments, the packaging material comprises residual nicotine in an amount from about 0.01%, about 0.05%, or about 0.1%, to about 0.25%, about 0.5%, or about 1% by weight. Determination of the residual nicotine may be performed by, for example, solid phase microextraction (SPME) coupled with gas chromatography-mass spectrometry and pyrolysis coupled with gas chromatography-mass spectrometry. Unless otherwise indicated, residual nicotine values disclosed herein are obtained by pyrolysis coupled with gas chromatography-mass spectrometry, further described in Example 1.

Certain regulatory bodies require a residual nicotine content of packaging materials of 0.25% or less in order for such material to be safely recycled or to be disposed of as non-hazardous waste. Accordingly, to take advantage of the environmental benefits of recycling, it is desirable to reduce levels of residual nicotine to levels at or below the regulated limits to enable recycling. As further described herein below, the method disclosed herein efficiently extracts residual nicotine from substrates such as packaging materials, providing materials for recycling or disposal having residual nicotine concentrations well below the regulatory threshold of 0.25% by weight.

In some embodiments, the substrate is a pouch or sachet. Pouches or sachets are typically made from laminated plastic films that include a closure mechanism, such as one or more of a zipper-type closure, a snap-fit mechanism, an adhesive, or a hook and loop fastener. Particularly, pouches or sachets may include a Zip-lock® type mechanism as available from SC Johnson. Laminated film pouches or sachets typically include at least three layers, for example, an outer printing layer made of a polyester, a high moisture barrier middle layer made of a metalized polyester, and an inner sealing layer made of a low-density polyethylene.

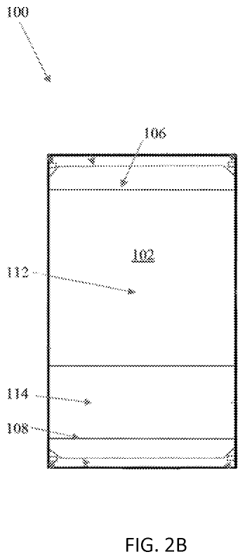

FIGS. 2A, 2B, and 2C are schematic side and front views of a multi-compartment flexible sachet container according to some example implementations; FIGS. 2A, 2B, and 2C depict three different views of a container 100 for storing smokeless tobacco or other oral product and having multiple compartments.

FIG. 2A is a side view of the container 100 without any material stored within the compartments 112, 114. The container 100 is generally shown having a flat, planar configuration when empty; however, there is a certain amount of empty space within the compartments and/or the materials are flexible to accommodate any product stored therein.

FIG. 2B is a front view of the container 100 and depicts the container 100 with a generally rectangular shaped outline; however, size and shape of the container can vary to suit a particular application, e.g., type of product, quantity of product, and size or shape of product. The closure mechanisms 106, 108 may be selected to suit a particular application and may include zipper-type closures (e.g., Ziploc® as available from SC Johnson) or similar snap-fit type closure mechanisms, an adhesive, a hook and loop type fastener (e.g., Velcro® as available from the Velcro Company), and folding. Typically, the closure mechanisms 106, 108 are two-part mechanisms, with a first part disposed on the front panel 102 and a second part disposed on the back panel 104. The two parts are brought into contact with one another to effect sealing (e.g., via a slider or application of a force (i.e., press and seal)). The closure mechanism halves may be attached to the panels via any of the manners known to a person of the skill in the art (e.g., sonic welding, adhesive, etc.).

FIG. 2C is an opposite side view of the container 100 depicting the container 100 in use, where a fresh product 130 is stored within the first compartment 112 and a waste product 132 (e.g., used chew) is stored within the second compartment 114.

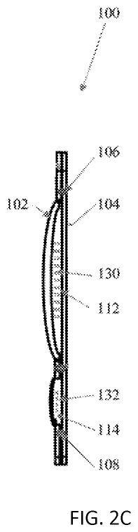

FIG. 3 depicts a roll of an exemplary material 300 for use as any of the panels described above and may include a lamination of paper/poly/metal/poly layers. The material 300 shown includes five layers, three basic or functional layers 300a, 300c, 300e, and two adhesive layers 300b, 300d disposed there between. The first functional layer 300a is typically a printing layer for application of, for example, a high-quality decoration, logo, etc. In some implementations, the first layer 300a is a 12 μm polyester (PET) film, however, the material and thickness this or any of the other layers may vary for a particular application. The first layer 300a may be configured for reverse printing making the inks, and by extension, logos, etc. scratch-proof. Additionally, the first layer 300a may have a matte, gloss, or combination finish, a textured surface, a surface varnish or other finishes as known to a person of skill in the art.

The second functional layer 300c is a barrier layer for maintaining product integrity and may be a 12 μm metalized polyester (MPET) film. The second functional layer 300c may be configured to provide a high moisture barrier, i.e., configured to be substantially fluid-impervious so as to prevent the flow of fluids from the internal compartments to the ambient environment. However, in some implementations, the second functional layer may include a material configured to allow for oxygen (or other gas) to diffuse into or out of the compartments while substantially resisting moisture loss therethrough.

The third functional layer 300e is a sealing layer, which also helps maintain product integrity. In some implementations, the third functional layer 300e may comprise a polyethylene material having a thickness in a range of about 55 μm to about 80 μm. In a particular implementation, the third functional layer 300e is a 70 μm low density polyethylene (LDPE) film. The third functional layer is the product contact layer and, depending on the product, may require regulatory approval for direct product contact. The adhesive layers 300b, 300d are provided to form a lamination or film that is used for the various panels as are known to a person of skill in the art. In various implementations, the materials used to manufacture the container render the container totally recyclable.

As an alternative to pouch storage, nicotine-containing products may be stored in a rigid container. Accordingly, in some embodiments, the substrate is a rigid container. Various types of rigid containers for storing and dispensing such products are known in the art and are often characterized by a hand-held size that can be easily stored and transported. For example, snus products have been packaged in tins, “pucks” or “pots” that are manufactured from plastics. See, for example, those types of containers generally disclosed in U.S. Pat. No. 4,098,421 to Foster; U.S. Pat. No. 4,190,170 to Boyd; U.S. Pat. No. 8,440,023 to Carroll et al.; U.S. Patent Pub. No. 2010/0065076 to Bergstrom et al.; U.S. Patent Pub. No. 2010/0065077 to Lofgreen-Ohrn et al.; U.S. Patent Pub. No. 2012/0024301 to Carroll et al., and U.S. Patent Pub. No. 2012/0193265 to Patel et al., each of which is incorporated by reference herein. Yet other types of containers for smokeless types of tobacco products are set forth in U.S. Pat. No. 8,458,996 to Bried et al.; D574,709 to Crotts et al. and D649,284 to Patel et al.; U.S. Patent Pub. Nos. 2008/0202956 to Welk et al., 2010/0012534 to Hoffman, 2010/0018883 to Patel et al., and 2014/0197054 to Pipes et al.; as well as the various types of containers referenced in U.S. Patent Pub. No. 2013/0206153 to Beeson et al., each of which is incorporated by reference herein. Further, U.S. Pat. No. 8,567,597 to Gibson et al. discloses a compartment container for snus and is incorporated herein by reference in its entirety.

Suitable containers such as those referenced above generally have a base or body portion and a cover or lid, where the cover, the body portion, or both include structure to provide sealing properties with respect to the products. A desirable feature for certain containers is the protection of the product from environmental effects, particularly those effects that may degrade the product stored in the container. For example, in humid environments, moisture may invade the storage space housing the product, thereby damaging the product or otherwise rendering the product unusable. In other instances, venting within the enclosure formed by the container may be needed for properly storing a product. The containers may also include structure to improve other characteristics of the container and the interface between the body portion and the lid, such as, for example, child-resistant features that make it difficult for a child to separate the cover and the body portion, thereby reducing the risk of children accessing the contents of the container. Such containers may also include a side label to prevent moisture loss from the product. Examples of containers that may incorporate such structures are described in U.S. Patent Publication Nos. 2022/0071280 to Patel et al. and 2022/0104543 to Patel et al., the entire disclosures of which are hereby incorporated by reference herein.

The shape of the outer surface of the container can vary. Container shape may be characterized in relation to a shape of a horizontal cross-section of the container. Typically, such cross-sectional shape may be substantially round or defining a circle. Other cross-sectional shapes are also encompassed, however, including oval, elliptical, triangular, square, rectangle, parallelogram, pentagon, hexagon, heptagon, octagon, and other geometric shapes.

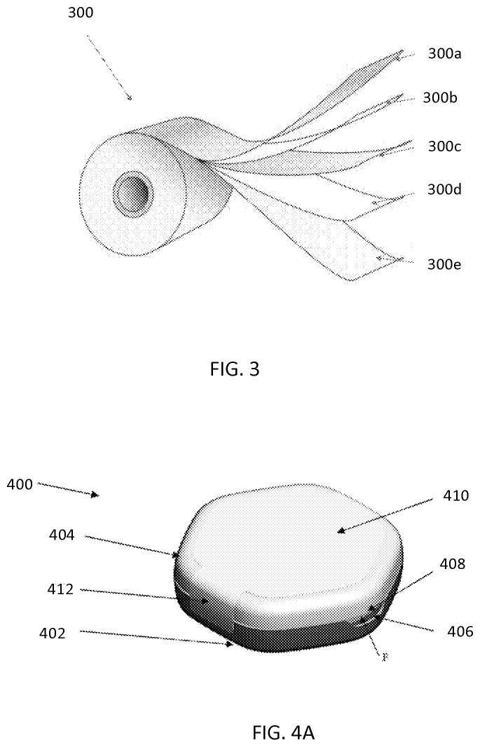

A non-limiting example of a suitable rigid container 400 is provided in FIGS. 4A and 4B. As shown in FIG. 4A, the cover 404 and body portion 402 generally abut one another when engaged and their respective outer surfaces are substantially flush with one another, which makes it difficult to separate the parts from their engaged or sealed position. In some implementations, the cover 404 is secured to the body portion 402 via a snap or interference fit, which provides additional resistance to separating the parts. The container may also include one or more labels 410a, 410b (collectively 410) attached to the base 402, the lid 404, or both. The labels 410 may be made from paper, a film, vinyl or a lamination of materials and may include indicia printed or otherwise deposited thereon including, for example, a logo, product information, or similar. With continued reference to FIG. 4A, the base portion 402 includes a cut-out or recess 406 that provides access to the lower edge 408 of the cover sidewall 418 to assist in removing or otherwise disengaging the cover 404 from the body portion 402, for example, by applying an upward force (F) to the lower edge 408 of the cover Referring to FIG. 4A and FIG. 4B, with the label 410 attached to the container 400, the tabs 412 extend over the outer sidewall 420 of the cover 404 and the secondary wall 416 of the body portion 402, thereby spanning an interface between the body portion and the cover (e.g., where the lower edge 408 of the outer wall 420 of the cover proximately abuts the upper edge of the secondary wall 416 of the body portion). Such containers are described in, for example, US Pat. Pub. No. 2023/0329334 to Patel et al., incorporated herein by reference.

See also, for example, the various types of containers for nicotine products that are set forth in U.S. Pat. No. 7,014,039 to Henson et al.; U.S. Pat. No. 7,537,110 to Kutsch et al.; U.S. Pat. No. 7,584,843 to Kutsch et al.; U.S. Pat. No. 8,397,945 to Gelardi et al., D592,956 to Thiellier; D594,154 to Patel et al.; and D625,178 to Bailey et al.; US Pat. Pub. Nos. 2008/0173317 to Robinson et al.; 2009/0014343 to Clark et al.; 2009/0014450 to Bjorkholm; 2009/0250360 to Bellamah et al.; 2009/0266837 to Gelardi et al.; 2009/0223989 to Gelardi; 2009/0230003 to Thiellier; 2010/0084424 to Gelardi; and 2010/0133140 to Bailey et al; 2010/0264157 to Bailey et al.; 2011/0168712 to Bailey et al.; and 2022/0297893 to Patel, each of which are incorporated herein by reference.

Suitable containers for nicotine products can be produced from polymeric materials such as polypropylene, polyethylene, polystyrene, polyamide, and the like by extrusion and/or molding into desired shapes. Various portions of the container may comprise different types of materials and/or materials having different hardnesses (e.g., some portions may be more flexible than other portions to, for example, provide for expansion, enhanced grip, ease of opening, etc.).

In some embodiments, the substrate is a waste (e.g., spent or used) polymeric packaging material, such as a container which has been previously used for storage of a product comprising nicotine (e.g., oral nicotine products) as described herein above. The nature of the waste polymeric packaging material may vary but is generally of the type referred to as a plastic. In some embodiments, the waste polymeric packaging material comprises a plastic of a type appropriate for recycling. Currently, plastics materials appropriate for recycling include polyethylene, polyethylene terephthalate, and possibly polypropylene. Additional or fewer plastics may be recycled according to region and available facilities. In some embodiments, the waste polymeric packaging material comprises polypropylene, polyethylene, polyvinyl chloride, an ethylene vinyl acetate co-polymer, polyvinylidene dichloride, a polyester terephthalate, an ethylene methacrylic acid co-polymer, or a combination thereof. In some embodiments, the waste polymeric packaging material comprises polypropylene, low-density polyethylene, or a combination thereof. Particularly desirable is the recycling of polyethylene-containing plastics, such as low- and high-density polyethylene, due to their ease of recycling and the abundance of these plastics. Accordingly, in some embodiments, the waste polymeric packaging material comprises or is polyethylene, such as low-density polyethylene.

In some embodiments, the waste polymeric packaging material is a sachet previously used for storage of a nicotine product, the sachet comprising a metallic layer and one or more polymeric layers. In some embodiments, the metallic layer is aluminum.

In some embodiments, the waste polymeric packaging material is a disposable container previously used for containing an aerosol forming composition for an electronically heated device (e.g., a pod from an e-cigarette or vape device).

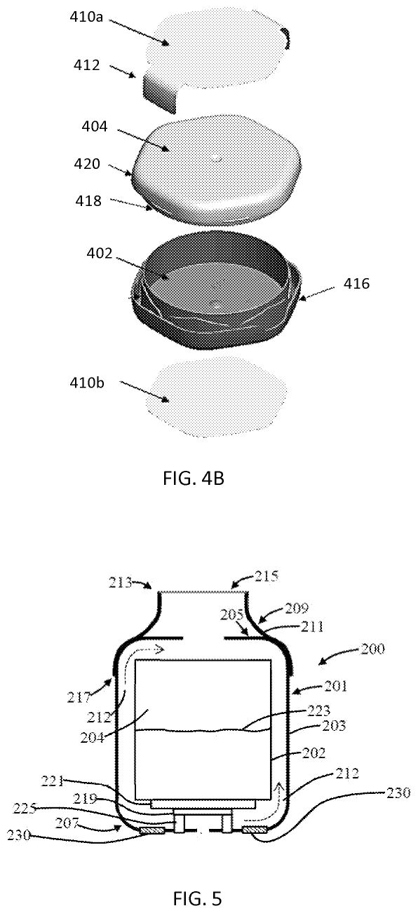

In some embodiments, the substrate can be a consumable used in aerosol-producing devices, such as e-cigarettes or tobacco heating devices. FIG. 5 a partial cross-sectional view of a cartridge for holding a nicotine solution (i.e., an e-liquid) that can be used as the substrate according to the present disclosure, particularly after the cartridge has been used and is ready to be discarded. A cartridge 200 for use in an aerosol delivery device of the present disclosure can comprise a tank 201 that is defined by an outer tank wall 203 that includes a proximal end 205 and a distal end 207. One or more mating connectors 230 can be present at the distal end 207 of the cartridge 200 and can be configured to form a connection with one or more mechanical connectors present in a control device (not shown). The cartridge 200 also can include one or more electrical contacts 225 that are configured to electrically connect the heater 219 with a battery in a control device (not shown). The tank 201 particularly can include an inner wall 202 that defines a reservoir 204 wherein the e-liquid or the like may be retained. An aerosol passage 212 can at least partially surround the reservoir 204 in a longitudinal direction from the distal end 207 to the proximal end 205 of the tank 201. The cartridge 200 further can comprise a mouthpiece 209 that is defined by an outer mouthpiece wall 211 that includes a proximal end 213 with an exit portal 215 and a distal end 217 that is engaging the proximal end 205 of the tank 201. The cartridge 200 further can include a heater 219 and a liquid transport element 221 that defines a fluid connection between the heater and a liquid 223 contained within the reservoir 204.

Accordingly, in some embodiments, the waste polymeric packaging material comprises a cyclohexylenedimethylene terephthalate glycol copolymer, such as a copolymer of dimethyl terephthalate, cyclohexanedimethanol, and 2,2,4,4-tetramethyl-1,3-cyclobutanediol.

### Receiving

The disclosed method of extraction generally comprises i) receiving a substrate as described herein; and ii) removing at least a portion of the nicotinic component from the substrate. By “receiving a substrate” is meant that the substrate, such as a container which has been previously used for storage of a product comprising nicotine (e.g., oral nicotine products), is obtained, provided, delivered, or the like, in a form suitable for performing the method. For example, in the case of a waste polymeric packaging material, the substrate is empty with respect to any previously contained product and may have been subject to initial processing. This initial processing may include, but is not limited to, physical removal of product, washing, e.g., with water, detergent, solvent, or combinations thereof.

Prior to or following the receiving, the substrate may be processed, e.g., to subdivide the material into smaller pieces by shredding, grinding, or other suitable operations, using, for example, equipment such as hammer mills, cutter heads, air control mills, or the like.

In some embodiments, the substrate (e.g., a waste polymeric packaging material) is subdivided by cutting or shredding into smaller pieces, such as pieces having a length in a range from about 0.5 cm to about 2 cm and a width from about 0.5 cm to about 2 cm. Alternatively, the substrate is subdivided by grinding the packaging material into a particulate material, such as a particulate material having an average particle size in the range from about 1000 microns to about 5000 microns. In some embodiments, the substrate (e.g., a waste polymeric packaging material) is subjected to cryogenic grinding. Although not bound by any theory of operation, it is believed that subdividing the packaging material prior to extraction improves the efficiency of the extraction due to increased surface area.

In some embodiments, the substrate is a pouch or packaging material comprising a metallic layer, and the method further comprises removing the metallic layer prior to the extracting. In some embodiments, removing the metallic layer comprises contacting the pouch or packaging material with an acid, dissolving the metallic layer.

### Removing the Nicotinic Component

The manner in which the extraction is performed may vary based on the type of substrate, the amount of the nicotinic component (e.g., residual nicotine), the physical form of the substrate, the quantity of the substrate to be processed, and the volume of substrate to be processed per unit of time.

Generally, the removing comprises:
a) contacting the substrate with a solution of a strong base in a solvent in a vessel to form a mixture;
b) heating the mixture at an elevated temperature to form a vapor containing the nicotinic component; and
c) releasing the vapor containing the nicotinic component from the vessel, forming a decontaminated substrate having a second concentration of the nicotinic component, wherein the second concentration of the nicotinic component is lower than the first concentration of the nicotinic component.

The strong base and the concentration thereof in the solvent may vary, but are generally selected to provide an alkaline environment capable of converting all nicotinic component present in or on the substrate to the free base form. As used herein, the term “strong base” refers to a compound that completely dissociates into its ions when dissolved in a solvent such as water, releasing a high concentration of hydroxide ions (OH−) and causing a significant increase in the solution's pH. In some embodiments, a pH of the solution of the strong base is about 9.5 or higher, such as about 9.5, about 10, about 10.5, about 11, about 11.5, about 12, about 12.5, about 13, about 13.5, or about 14.

In some embodiments, a concentration of the strong base in the solvent is from about 0.1 to about 10 molar (M) such as about 0.1, about 0.5, or about 1 molar, to about 2, about 5, or about 10 molar.

In some embodiments, the strong base is an alkali metal hydroxide. Suitable alkali metal hydroxides include lithium, sodium, and potassium hydroxide.

In some embodiments, the strong base is ammonium hydroxide, such as concentrated aqueous ammonium hydroxide or a methanolic ammonia.

Suitable solvents include, but are not limited to, solvents in which the strong base and free base nicotine and/or nicotine salts exhibit good solubility. Suitable solvents have a boiling point at standard pressure below the melting point of the substrate and are chemically compatible with the substrate. In some embodiments, the solvent has a boiling point at standard atmospheric pressure in a range from about 50° C. to about 150° C., such as from about 50° C., about 60° C., about 70° C., about 80° C., about 90° C., or about 100° C., to about 110° C., about 120° C., about 130° C., about 140° C., or about 150° C. In some embodiments, the solvent has boiling point at standard atmospheric pressure in a range from about 60° C. to about 90° C.

In some embodiments, the solvent is a polar organic solvent (e.g., a C1 to C3 alcohol, such as methanol, ethanol, n-propanol, or isopropanol). In some embodiments, the solvent is methanol. In some embodiments, the solvent is ethanol.

The conditions under which the contacting, heating, and/or releasing are performed may vary based on, for example, the specific substrate, the quantity and form of substrate, and the concentration of nicotinic component (e.g., residual nicotine) present in the substrate. The contacting, the heating, or both may be repeated, e.g., as multiple cycles, such as two times, three times, or more as necessary or desired.

The contacting and subsequent heating are conducted in a vessel. Suitable vessels include but are not limited to glass and metal reactors having a chamber of an appropriate volume to accommodate the solvent and substrate. The vessel can be open or sealed. Additional features of the vessel are described further herein below.

Reference herein to the term “mixture” is intended to encompass the combination of the substrate and the solution of strong base in contact with one another. The nature of the mixture may take different forms depending on the physical form of the substrate. For example, solid substrates such as polymeric materials previously utilized for the containment and/or storage of products comprising a nicotinic component will be understood to be present in solid form in intimate contact with the solution. Conversely, substrates which are liquid compositions, such as vapor precursor formulations (i.e., an “e-liquid” or “vape juice”), will be understood to dissolve in the solution of strong base and solvent and to be present in solution form. Other substrate forms such as tobacco or botanical materials, resin-bound nicotinic complexes and the like may be present as a slurry, suspension, or other non-homogenous mixture.

Generally, the contacting of the substrate with the solution of the strong base in the solvent is performed for a time and at a temperature sufficient to convert all of the nicotinic component present to the free base form. Generally, increasing solvent temperature and/or providing conditions which promote diffusion of the residual nicotinic component into the solvent enhance decrease the amount of time necessary. In some embodiments, the contacting is conducted at a temperature from about 20° C. to about 200° C., such as from about 20° C., about 30° C., about 40° C., or about 50° C., to about 100° C., about 150° C., or about 200° C. In some embodiments, the contacting is conducted at a temperature from about 20° C. to about 100° C., or from about 20° C. to about 50° C. In some embodiments, the contacting is conducted at a temperature at or below the boiling point of the solvent at standard atmospheric pressure. In some embodiments, the contacting is conducted at a temperature below that of the boiling point of the solvent at standard atmospheric pressure. In some embodiments, the contacting is conducted at a temperature which is approximately the same as the boiling point of the solvent at standard atmospheric pressure. In some embodiments, the contacting is conducted at a temperature above the boiling point of the solvent. Achievement of temperatures above the normal boiling point may be achieved by heating the solvent under pressure. In some embodiments, the vessel is sealed and under pressure to maintain the solvent in a liquid state.

The contacting may be performed for various lengths of time. In some embodiments, the contacting of the solvent, strong base, and substrate is performed for a first period of time prior to said heating in step b). In some embodiments, the first period of time is from about 5 minutes to about 2 days, such as from about 30 minutes, about 60 minutes, or about 2 hours, to about 4 hours, about 8 hours, about 12 hours, about 24 hours, or about 48 hours. In some embodiments, the first period of time is from about 30 minutes to about 24 hours.

The method comprises heating the mixture at an elevated temperature to form a vapor containing the nicotinic component. The elevated temperature is generally in a range from about 50° C. to about 200° C., such as from about 50° C., about 60° C., about 70° C., about 80° C., or about 90° C., to about 100° C., about 150° C., or about 200° C. In some embodiments, the elevated temperature at which the solvent is provided is approximately the same as the boiling point of the solvent at standard atmospheric pressure. In some embodiments, the elevated temperature at which the solvent is provided is below that of the boiling point of the solvent at standard atmospheric pressure.

The mixture of solvent, substrate, and strong base may be heated in various manners, such as by exposing the mixture to a conventional (e.g., radiant, convective, or direct contact) thermal source, or by exposure to microwave irradiation.

As described above, the contacting and/or heating may conducted more than once. For example, multiple cycles of contacting, with or without heating, may be performed. The cycles may reuse the solvent-strong base solution, or fresh solution may be added for additional cycles.

In some embodiments, the contacting of step a) and the heating of step b) are conducted simultaneously, at a temperature from about 50° C. to about 200° C. Accordingly, the nicotinic component is converted to the free base and vaporized during the same operation. In other embodiment, the contacting of step a) and the heating of step b) are conducted as separate, discrete operations (e.g., at different temperatures and/or different times).

In some embodiments, the contacting of step a) and the heating of step b) are performed at a pressure equal to or less than atmospheric pressure. One of skill will recognize that depending on the boiling point of the solvent, some portion of the solvent may be lost to vaporization during said contacting/heating. Further, it may be desirable in some embodiments to add fresh solvent, additional strong base, or both during the contacting and/or heating steps. For example, in a continuous process where additional substrate is added, it may be necessary to add additional solvent or strong base solution to maintain volume, ensure effective contact of the solution with the substrate, and maintain a pH at or above about 9.5. Accordingly, on some embodiments, the method further comprises adding an additional amount of solvent, adding an additional amount of the solution of a strong base in a solvent, or both, during or after any one or more of steps a) through c). The amount of such solvent or solution to be added may be determined by one of skill in the art.

In some embodiments, the contacting of step a), the heating of step b), or both are performed at a pressure greater than atmospheric pressure.

The method comprises releasing the vapor containing the nicotinic component from the vessel. This may be accomplished in numerous ways depending upon whether the heating of step b) is conducted at atmospheric pressure, below atmospheric pressure, or above atmospheric pressure. Generally, the releasing comprises allowing the vapor containing the nicotinic component to migrate from the vessel to another container or collection means by distillation and condensation, by allowing the vapor under pressure to escape by venting the vessel, or by applying a vacuum to the vessel, and subsequently allowing the vapor to condense into a liquid.

In some embodiments, the method further comprises condensing the vapor to a liquid state, such as by contacting the vapor with a cold surface (i.e., a condenser), and colleting the condensate.

In some embodiments, the vessel is in fluid communication with an external containment system configured to capture the vapor containing the nicotinic compound. In some embodiments, the external containment system comprises a solid adsorbent configured to capture the vapor, and the method comprises passing the vapor containing the nicotinic component through a bed of solid adsorbent. In some embodiments, the solid adsorbent comprises activated carbon, a zeolite, activated alumina, a solid phase microextraction fiber, or a combination thereof.

In some embodiments, in addition to or in place of the solid absorbent, the external containment system comprises a vessel containing an acidified solvent, and the method comprises passing the vapor containing the nicotinic component through the acidified solvent. Suitable acidified solvents include, but are not limited to, aqueous or alcohol solutions of mineral acids. The acid, concentration of acid, and volume of solution may be selected based on factors such as the quantity of nicotinic component to be captured. The acid, concentration thereof, and volume thereof is generally such that the acidified solvent maintains a pH of about 5 or less during the capture of the vapor. Suitable acids include, but are not limited to, hydrochloric, sulfuric, phosphoric, and acetic acids. Concentrations of such acids in solution may range from about 0.1M to about 18M, but are typically in a range of about 0.1 to about 3M. During the capture of vapor, or between cycles of capture, the acidified solvent may be refreshed or replaced.

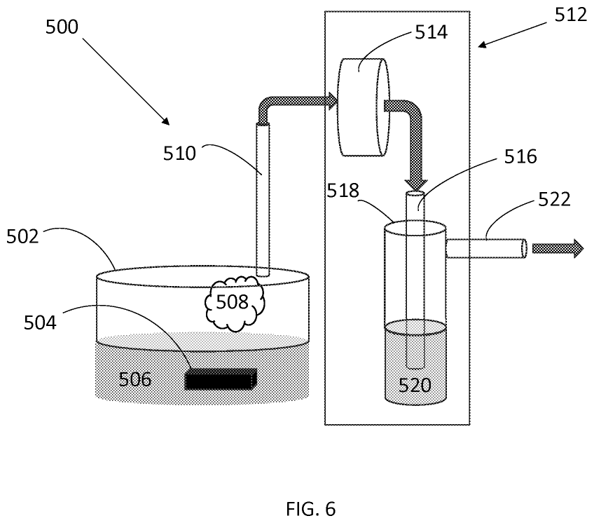

A system including a suitable vessel and associated containment system according to a non-limiting embodiment, the containment system comprising both a solid adsorbent and an acidified solvent, is illustrated in FIG. 6. With respect to FIG. 6, the system 500 comprises a vessel 502 which contains a substrate 504 in contact with a solution 506 of strong base in solvent. The system 500 is configured to allow the vapor 508 to migrate from the vessel 502 through conduit 510. The vapor 508 enters containment system 512, passing through a container 514 containing a solid adsorbent, then into a collection vessel 518 via conduit 516. The terminus of the conduit 516 is positioned below the surface of acidified solvent 520. As the vapor 508 bubbles through the acidified solvent 520, any remaining nicotinic component in the vapor 508 is dissolved in the solvent 520. The container 518 is vented to the atmosphere through conduit 522.

In some embodiments, the external containment system 512 is further configured to capture any solvent vaporized from the vessel 502, such as with a cold trap or other condensing and/or adsorbing means (not shown).

Following the complete removal of vaporized nicotinic component, the substrate 504 is present in the vessel in a decontaminated form. Generally, the decontaminated substrate has a second concentration of the nicotinic component, which is lower than the first concentration of the nicotinic component. In other words, substantially all of the nicotinic component has been removed from the substrate.

In some embodiments, at least a portion of the solvent remains in the vessel 502 following step c) noted above. Accordingly, in some embodiments, the method further comprises separating the decontaminated substrate from the solvent. The separating may comprise any means of physical removing the solvent from contact with the substrate. In some embodiments, the substrate is removed from the solvent. In some embodiments, the solvent is removed from contact with the decontaminated substrate by e.g., draining away the solvent through appropriate valves, pipes, filters, and the like.

In some embodiments, the substrate comprises residual solvent following the separating. In some embodiments, the method further comprises removing any residual solvent from the decontaminated substrate. Removal of residual solvent may be achieved by washing the decontaminated substrate with water, by drying in air at ambient or elevated temperature, or a combination thereof.

In some embodiments, the substrate is a waste polymeric material as described herein above, and the decontaminated waste polymeric material is suitable for recycling (i.e., the material has a residual nicotine content below a pre-determined threshold, such as less than 0.25% by weight). In some embodiments, the waste polymeric packaging material so obtained is suitable for recycling, containing nicotine in an amount of about 0.25% or less, such as 0.25%, 0.2%, 0.15%, 0.1%, 0.05%, 0.01%, 0.001%, 0.0001%, or even 0%.

The concentration of nicotinic component (e.g., nicotine) remaining in the substrate following performance of the disclosed method can be determined by GC pyrolysis as set forth in Example 1 herein. For example, a portion of an extracted sample of the waste packaging material can be subjected to GC pyrolysis.

Many modifications and other embodiments of the disclosure will come to mind to one skilled in the art to which this disclosure pertains having the benefit of the teachings presented in the foregoing description. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### EXAMPLES

Aspects of the present disclosure are more fully illustrated by the following examples, which are set forth to illustrate certain aspects of the present disclosure and are not to be construed as limiting thereof.

### Example 1. General Procedure for Determination of Nicotine Content of Plastic Sample by Pyrolysis-Gas Chromatography

A sample of the appropriate plastic material (2 mg sample weight) is vaporized with a pyrolysis accessory (filament type Pyroprobe Model 5200 with autosampler; CDS Analytical, CDS, Oxford, PA 19363, USA), and the resulting vapor injected onto an Agilent 7890B/5977B GC/MS with a High Efficiency Source (HES; Agilent; Wilmington, DE 19808, USA) using a DB-1701 type column. The pyrolysis is performed in flash mode in helium at a pyrolysis temperature Teq of 350° C. The total heating time THt is 20 seconds, and the heating rate is 20° C./ms. The GC/MS analysis parameters are listed in Table 1.

TABLE 1
Parameters for GC/MS on-line analysis of pyrolysates

| Parameter | Value | |
|---|---|---|
| Column | DB-1701 | |
| Column dimensions | 60 m; 0.25 mm ID | |
| Film thickness | 1 | mm |
| Initial oven temperature | 37° | C. |
| Initial time | 4.0 | min |
| Ramp rate | 2° | C./min |
| oven temperature first ramp | 60° | C. |
| Final first ramp time | 0 | min |
| Oven ramp rate | 5° | C./min |
| Oven final temp | 280° | C. |
| Final time | 20 | min |
| Total run time | 75.5 | min |
| Inlet temp | 280° | C. |
| Inlet mode | Split | |
| carrier | Helium | |
| Flow mode | Constant | |
| Flow rate | 1.1 | ml/min |
| Initial pressure | 17.5 | psi |
| Split ratio | 70:1 | |
| Split flow | 76 | ml/min |
| GC outlet | MSD | |
| Outlet pressure | Vacuum | |
| MSD transfer line temp | 280° | C. |
| Ion source temp | 230° | C. |
| Quadrupole temp | 150° | C. |
| MSD EM offset | 250 | V |
| MSD solvent delay | 2.0 | min |
| MSD acquisition mode | TIC | |
| Mass range | 29-550 | a.u. |

### Example 2. Evaluation of Conditions for Nicotine Extraction from Plastic Samples

Sodium hydroxide (5 wt %) in methanol and 2M ammonium hydroxide in methanol were used as bases to convert the nicotine in plastic samples to volatile, free-base nicotine, allowing nicotine vapors to be absorbed onto a Solid Phase Microextraction (SPME) fiber inserted through a vial cap.

Plastic samples (0.1 g and 0.2 g) from an oral pouched product container were combined with 10 mL of 5% sodium hydroxide in scintillation vials. These samples were sonicated at 50° C. for 1 hour each. A portion (1 μL) of the methanolic sodium hydroxide solution used to form the free base nicotine was put into a headspace vial with of quinoline-d6 internal standard (ISTD; 1 μL). In addition, aliquots (5 mL) of solution were put into separate headspace vials containing 1 mL of hexane and 1 μL of ISTD.

Similarly, plastic samples from an oral pouched product container weighing 0.1 g and 0.2 g were combined with 10 mL of 2M ammonium hydroxide in methanol in scintillation vials. These samples were sonicated at 50° C. for 1 hour each. A portion (1 μL) of the methanolic ammonium hydroxide solution used to form the free base nicotine was put into a headspace vial with of quinoline-d6 internal standard (ISTD; 1 μL). In addition, aliquots (5 mL) of solution were put into separate headspace vials for evaluation.

A control plastic sample from an oral pouched product container (0.2 g) was added to a headspace vial with 1 μL of ISTD and no other solvent.

After the heating and sonication, an SPME fiber filter was placed in each vial. The vials were heated from 35° C. to 200° C. over 10 minutes. The SPME fiber filters were then taken out of the vials and put into a GCMS inlet where they were heated to release adsorbed volatiles for analysis.

The aliquots of the extraction solvents (the sodium hydroxide and ammonium hydroxide methanol solutions) did not contain any nicotine. The hexane (head space vials) also did not contain any nicotine. Without wishing to be bound by theory, it is believed that a loss of nicotine occurred when the aliquot was moved between the scintillation vial and the headspace vial. The control vial produced a nicotine signal, suggesting that the transfer of samples allowed nicotine to escape. The results confirm that nicotine can be converted into its volatile, free-base form.

### Example 3. Evaluation of Solvent Volume for Nicotine Extraction from Plastic Samples

Plastic samples (0.2 g and 0.5 g) from an oral pouched product container were placed in separate headspace vials containing 2.5, 5, or 10 mL of 2M ammonium hydroxide in methanol with an ISTD (quinoline-d6). An additional plastic sample was heated with 1 mL of 2M ammonium hydroxide in methanol, 1 μL of ISTD, and 1 mL of dichloromethane in a headspace vial. The sample vials were transferred using a Gerstel MPS to an incubator set at 140° C. and heated for 15 mins. Following the incubation, a SPME fiber was inserted into the vial for 5 minutes to adsorb any nicotine present. Following this, the fiber was transferred to the inlet of a GC for analysis. The total desorption time was 420 seconds. The GC inlet temperature was maintained at 250° C. The oven heating program was as follows: 50° C., hold for 2 minutes; ramp 30° C./min to 210° C.; hold for 2 minutes; ramp 30° C./min to 240° C.; hold for 3 minutes. Total runtime was 13.33 minutes. Data was acquired by mass spectrometry, operating in positive mode and scanning from 25 da to 200 da.

The 0.2 g samples were shown to contain nicotine. The 0.5 g samples also were shown to contain nicotine but released too much nicotine under the analysis conditions for proper analysis; when analyzing a blank vial (containing no plastic) containing the previously desorbed fiber, the fiber released more nicotine. This indicates that the fiber was saturated, and the desorption time was not adequate to fully desorb the nicotine in the GC inlet. Accordingly, a maximum sample size of 0.2 g is indicated, along with an increase in fiber desorption time in the GC inlet to 7 minutes and an increase in heating time to better clean the fiber. The sample prepared with 10 ml of solvent could not be analyzed due to rupture of the septum.

Notably, in each sample, the solvent completely evaporated during heating. The samples prepared with ammonium hydroxide in methanol without DCM were observed to be clear, while the sample with DCM was cloudy. This indicates that the DCM broke down the plastic. The peak areas for the different amounts of ammonium hydroxide and DCM are provided in Table 2. With reference to Table 2, the peak area drastically decreased when DCM was present. The resultant chromatograms were also littered with artifact peaks that increased the noise and background. The extraction that utilized 2.5 mL of 2M ammonium hydroxide in methanol, when compared to the extraction using 5.0 mL of 2M ammonium hydroxide in methanol, showed good linearity (slightly doubled the peak area).

TABLE 2
Nicotine extraction results with various solvent volumes

| | Nicotine total |
|---|---|
| Solvent /Volume | area count |
| 2M ammonium hydroxide | 16,753,044 |
| in methanol; 2.5 mL | |
| 2M ammonium hydroxide | 39,978,761 |
| in methanol; 5.0 mL | |
| 2M ammonium hydroxide | 634,536 |
| in methanol (1 mL) plus | |
| dichloromethane (1 mL) | |

### Example 4. Evaluation of Dichloromethane Solvent Volume for Nicotine Extraction from Plastic Samples

Four plastic samples (0.1 g each) from an oral pouched product container were placed in separate headspace vials containing 500 μL or 2.5 mL of 2M ammonium hydroxide in methanol. To two of the vials was added dichloromethane (250 μL or 300 μL). All samples were heated at 60° C. for 15 minutes. The peak areas for the different amounts of dichloromethane (DCM) are provided in Table 3. With reference to Table 3, the data indicate that DCM decreases extraction efficiency and/or ionization efficiency of nicotine, and that larger volumes of ammonium hydroxide solution appears to be beneficial in more fully extracting nicotine. This result may be due to the increased solvent volume taking longer to evaporate and allowing more nicotine to be volatilized and extracted from the plastic.

TABLE 3
Nicotine extraction results with cosolvent addition

| | | |
|---|---|---|
| Volume of 2M | | |
| ammonium hydroxide | Volume of | Nicotine total |
| in methanol | dichloromethane | area count |

| | | | |
|---|---|---|---|
| 500 | uL | 250 uL | 490,078 |
| 500 | uL | 300 uL | 478,004 |
| 2.5 | mL | 0 | 5,709,937 |
| 500 | uL | 0 | 226,736 |

### Example 5. Evaluation of Extraction Temperature on Nicotine Extraction from Plastic Samples

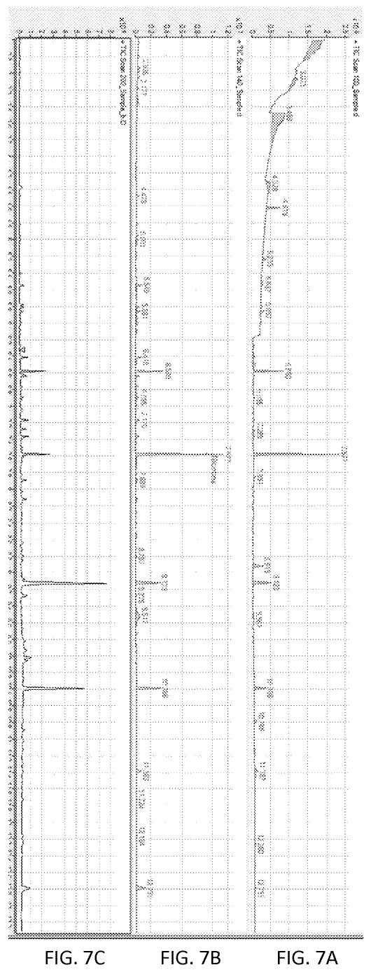

Five plastic samples (0.1 g each) from an oral pouched product container were placed into separate headspace vials containing 2.5 mL of 2M ammonium hydroxide in methanol. Different oven temperatures were used to evaluate extraction efficiency at 5 different times and temperatures. Two empty vials and one solvent blank with no plastic was run before each temperature point. All samples contained ISTD quinoline-d6. The results are provided in Table 4 and FIGS. 7A-7C. With reference to Table 4 and FIGS. 7A-7C, the data indicate that the sample extracted at 140° C. (FIG. 7B) had the highest signal intensity and signal to noise ratio. No data was obtained for the 30-minute sample as the plastic melted.

TABLE 4
Nicotine extraction results at various temperatures

| | Time | Nicotine total |
|---|---|---|
| Temperature | (minutes) | area count |
| 60° C. | 15 | 26851 |
| 100° C. | 15 | 1934058 |
| 140° C. | 15 | 9643106 |
| 200° C. | 15 | 2146740 |
| 200° C. | 30 | NA |

### Example 6. Evaluation of Solvent on Nicotine Extraction from Plastic Samples

Four plastic samples (0.05 g each) from an oral pouched product container were placed into separate headspace vials containing 800 μL of 2M ammonium hydroxide in methanol (MeOH), 2M ammonium hydroxide in acetonitrile (ACN), 2M ammonium hydroxide in ethyl acetate (EtAc), or 2M ammonium hydroxide in ethyl acetate/acetonitrile (Table 5). Two empty vials and one solvent blank with no plastic were run before each temperature point. All samples contained ISTD quinoline-d6 and ISTD Anethole.

All septa remained intact for this experiment. The samples that were extracted with ACN or MeOH showed complete solvent evaporation, while the EtAc/ACN sample had a substantial amount of solvent left post-extraction. Data are provided in Table 5. With reference to Table 5, the sample extracted with ammonium hydroxide in methanol showed the greatest peak area for nicotine and for both ISTD's that were utilized.

TABLE 5
Nicotine extraction results with various solvents

| | Nicotine | Anethole | Quinoline |
|---|---|---|---|
| Solvent | Area | Area | Area |
| MeOH | 21,171,399 | 3,732,999 | 5,131,206 |
| ACN | 5,961,955 | 2,619,209 | 3,548,097 |
| EtAc | 2,887,360 | 1,452,023 | 1,501,135 |
| ACN + EtAc | 543,956 | 346,998 | 423,157 |

### Example 7. Nicotine Extraction from Product Containers

Residual nicotine was extracted from previously used product containers according to an embodiment of the disclosure. Oral pouched product containers were separated into component pieces (bottom layer and inner liner) and three samples of each were obtained, each weighing about 0.05 grams. The weights were recorded for the component samples, which were kept separate and analyzed individually. The individual samples were placed into separate headspace vials containing 800 μL of 2M ammonium hydroxide in methanol and 1 μL each of anethole and quinoline d-7 as internal standards. The samples were heated at 140° C. for 5 minutes each. After the heating, a SPME fiber filter was placed in each vial. The heating and introduction of fresh alkaline solvent was repeated a second time to completely extract the nicotine.

The vials were heated to 140° C. for 5 minutes per heating cycle with two cycles per vial per experiment at different times during the run. The SPME fiber filters were then taken out of the vials and put into a GCMS inlet where they were heated to release adsorbed volatiles for analysis as in Example 2 but using a split ratio of 200:1. The sample weights and quantity of nicotine desorbed from the SPME fiber (i.e., quantity of extracted nicotine) from each sample are provided in Table 6. Each sample was then subjected to a second extraction using identical solvent, volume, and internal standards. The results of the second nicotine extraction are also provided in Table 6.

The multiplier in Table 6 is calculated with the following equation: replicate mass/volume of solvent used per extraction. The multiplier is necessary to account for the volume of the vaporized alkaline solvent in the vial headspace and the volume of the plastic. In addition, the multiplier allows for back calculation since the SPME fiber only absorbs a portion of the nicotine in the headspace. Final Mass in Table 6 is final mass of nicotine in micrograms. It is the 1^{st} extracted nicotine and 2^{nd} extracted nicotine masses multiplied by the multiplier summed. The % residual nicotine in Table 6 is calculated as [final mass of nicotine/(total sample mass×1000000)]×100. The 1000000 is needed to get the micrograms of nicotine into grams.

TABLE 6
Nicotine extraction results

| | | | nicotine | nicotine | Total | | | |
|---|---|---|---|---|---|---|---|---|
| | | Sample | quantity | quantity | Nicotine | | Final | % |
| Sample | Sample | weight | extracted | extracted | extracted | Multiplier | Mass | Residual |
| ID | # | (g) | (1^{st}) (μg) | (2^{nd}) (μg) | (μg) | (vol/weight) | (μg) | Nicotine |
| Bottom | 1 | 0.049 | 23.97 | 8.66 | 32.64 | 32.13 | 1048.74 | |
| layer | 2 | 0.052 | 109.31 | 8.39 | 117.70 | 30.84 | 3629.95 | |
| | 3 | 0.054 | 43.01 | 22.76 | 65.77 | 29.46 | 1937.66 | |
| Inner | 1 | 0.0497 | 111.31 | 3.74 | 115.05 | 32.19 | 3703.05 | |
| liner | 2 | 0.053 | 50.33 | 10.86 | 61.18 | 30.39 | 1859.28 | |
| | 3 | 0.052 | 58.33 | 23.82 | 82.16 | 30.93 | 2541.05 | |
| Sum of | 1 | 0.0995 | 135.28 | 12.40 | 147.68 | 32.16 | 4749.66 | 0.041 |
| bottom | 2 | 0.104 | 159.63 | 19.25 | 178.88 | 30.61 | 5476.19 | 0.047 |
| and inner | 3 | 0.106 | 101.34 | 46.58 | 147.93 | 30.18 | 4464.04 | 0.038 |
| liner | | | | | | | | |

### Example 8. Efficiency of Nicotine Extraction from a Product Container Sample

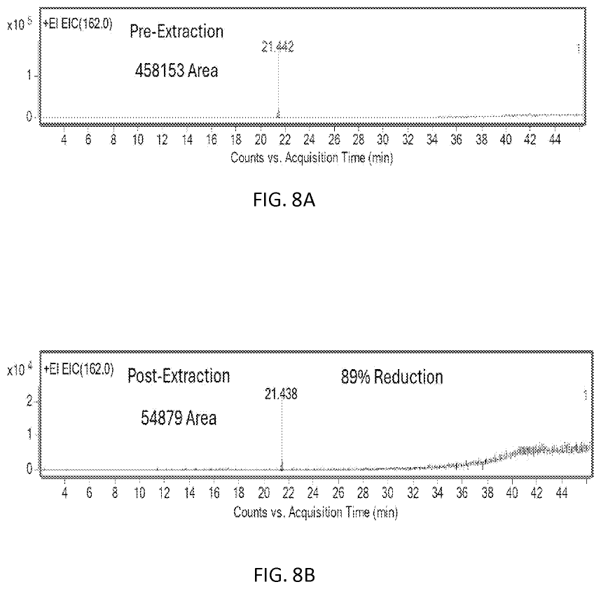

Samples of approximately 0.001 g each were obtained from a previously used oral pouched product container. A sample was analyzed by pyrolysis as described in Example 1. A second sample from the same container was subject to two extractions according to Example 7. Following the two extractions, the sample was analyzed by pyrolysis. The pre- and post-extraction areas by GCMS are shown in FIGS. 8A and 8B, respectively. With reference to FIGS. 8A and 8B, the area (corresponding to nicotine concentration) after extraction was reduced by 89%. The residual percent nicotine following the second extraction was calculated as 0.042%.

What is claimed is:

1. A method for extracting a nicotinic component from a substrate comprising the nicotinic component at a first concentration, the method comprising:
i) receiving the substrate; and
ii) removing at least a portion of the nicotinic component from the substrate, wherein removing comprises:
a) contacting the substrate with a solution of a strong base in a solvent in a vessel to form a mixture;
b) heating the mixture at an elevated temperature to form a vapor containing the nicotinic component; and
c) releasing the vapor containing the nicotinic component from the vessel, forming a decontaminated substrate having a second concentration of the residual nicotinic component, wherein the second concentration of the residual nicotinic component is lower than the first concentration of the residual nicotinic component.

2. The method of claim 1, wherein a pH of the solution of the strong base is about 9.5 or higher.

3. The method of claim 1, wherein a concentration of the strong base in the solvent is from about 0.1 to about 10 molar (M).

4. The method of claim 1, wherein the strong base is an alkali metal hydroxide.

5. The method of claim 1, wherein the strong base is ammonium hydroxide.

6. The method of claim 1, wherein the solvent comprises water, a polar organic solvent, or a combination thereof.

7. The method of claim 1, wherein the solvent comprises methanol or ethanol.

8. The method of claim 1, wherein contacting the substrate with the solution of the strong base in the solvent is performed at a temperature from about 20° C. to about 200° C., such as from about 20° C. to about 50° C.

9. The method of claim 8, wherein the contacting is performed for a first period of time prior to said heating in step b), the first period of time being from about 5 minutes to about 2 days, such as from about 30 minutes to about 24 hours.

10. The method of claim 1, wherein in step b), the elevated temperature is in a range from about 50° C. to about 200° C.

11. The method of claim 1, wherein step a) and step b) are conducted simultaneously, at a temperature from about 50° C. to about 200° C.

12. The method of claim 1, wherein the contacting and/or the heating is performed under a pressure equal to or less than atmospheric pressure.

13. The method of claim 12, wherein step ii) further comprises adding an additional amount of solvent, adding an additional amount of the solution of a strong base in a solvent, or both, during or after any one or more of steps a) through c).

14. The method of claim 1, wherein the contacting and/or the heating is performed at a pressure greater than atmospheric pressure.

15. The method of claim 1, wherein the vessel is in fluid communication with an external containment system configured to capture the vapor containing the nicotinic compound.

16. The method of claim 15, wherein the external containment system is further configured to capture any solvent vaporized from the vessel.

17. The method of claim 15, wherein releasing the vapor containing the nicotinic compound from the vessel comprises venting the vessel to an external containment system.

18. The method of claim 1, wherein at least a portion of the solvent remains in the vessel following step c).

19. The method of claim 18, further comprising separating the decontaminated substrate from the solvent.

20. The method of claim 1, further comprising removing residual solvent from the decontaminated substrate, such as by washing the decontaminated substrate with water, drying the decontaminated substrate, or both.

21. The method of claim 1, wherein the second concentration of the residual nicotinic component is about 0.25% nicotine by weight or less, such as about 0.1% nicotine by weight or less, or about 0.0001% to about 0.01% nicotine by weight, based on the total weight of the decontaminated substrate.

22. The method of claim 1, wherein the external containment system comprises a solid adsorbent configured to capture the vapor, the method comprising passing the vapor containing the nicotinic component through a bed of solid adsorbent.

23. The method of claim 22, wherein the solid adsorbent comprises activated carbon, a zeolite, activated alumina, a solid phase microextraction fiber, or a combination thereof.

24. The method of claim 1, wherein the external containment system comprises a vessel containing an acidified solvent, the method comprising passing the vapor containing the nicotinic component through the acidified solvent.

25. The method of claim 1, wherein the substrate comprises an e-liquid composition.

26. The method of claim 1, wherein the substrate comprises a polymeric material, an ion exchange resin, a tobacco material, a non-tobacco botanical material, or a combination thereof.

27. The method of claim 1, wherein the substrate comprises a waste polymeric packaging material previously used for storage of a product comprising nicotine.

28. The method of claim 27, further comprising dividing the substrate into smaller pieces prior to the contacting.

29. The method of claim 28, wherein the dividing comprises one or more of cutting or shredding the substrate into smaller pieces or grinding the substrate into particles.
